(19) United States
(12) Patent Application Publication
(10) Pub. No.: US 2005/0236482 A1
(43) Pub. Date: Oct. 27, 2005

(54) Digital carrier for data storage and device for reading and/or reading/writing said carrier

(76) Inventor: Claudio Olette, Torino (IT)

Correspondence Address: BACON & THOMAS, PLLC, 625 SLATERS LANE, FOURTH FLOOR, ALEXANDRIA, VA, 22314, US

(21) Appl. No.: 10/829,199

(22) Filed: Apr. 22, 2004

(51) Int. Cl. G06K 7/10; G06K 7/14; G06K 19/00

(52) U.S. Cl. 235/454; 235/487

(57) ABSTRACT

The present invention concerns a digital carrier for data storage, which carrier has no through hole, is preferably made as a card conforming to ISO standard 7810 and has an optical surface that can be read/written in an optical disc reader/writer. Said carrier comprises, at the center of said annular surface, a body that can be magnetically attracted whereby at least one face of the carrier is obtained that is wholly available for printing processes. The invention further concerns a device for reading and/or reading/writing said digital carrier.

### FIELD OF THE INVENTION

The present invention relates to a digital carrier for data storage and to a device for reading and/or reading/writing said carrier.

More particularly, the invention concerns a data storage carrier having an optical annular surface that can be read/written by means of a laser reading and/or reading/writing device.

The present invention further concerns a laser reading and/or reading/writing device suitable for use together with said digital carrier.

### BACKGROUND OF THE INVENTION

In recent years, there has been a growing diffusion of information storage carriers in the form of rectangular cards of plastic material, especially polycarbonate, provided with an optical surface defining an annulus where data and information can be recorded. Of particular interest are the so-called hybrid cards (optical memory cards) comprising an optical annular surface together with a chip, a magnetic strip, a bar code, or a combination of said storage means. Said cards might be used especially in the public administration field, for instance as identification cards, health-service cards, etc.

Said cards must conform to ISO standard 7810 in order they can be utilized in the readers of automatic machines (ATMS, POS devices and the like) capable of reading the magnetic strip and/or the chip possibly provided. In particular they must have a size of 86×54×0.76 mm, which must be uniform over the whole card surface. Moreover, the magnetic strip and/or the chip must be located in predetermined positions on said cards.

On the other hand, hybrid cards must conform to CD and DVD reading, recording and playing standards, so that the optical annular surface can be read and/or written by using the CD/DVD drives of personal computers. CD/DVD technology allows considerably increasing the data storage capacity, up to 100-200 Mbytes in case of digital carriers conforming to ISO standard 7810.

In recent years, hybrid cards comprising both an optical annular surface and a magnetic strip, a chip and/or a bar code have been developed. Said cards can be used with standard CD or DVD readers/writers, such as the CD/DVD drives of personal computers, but they do not conform to ISO standard 7810. An example of such hybrid cards is disclosed in WO 00/58907.

As known, such cards equipped with an optical annular surface, in order they can be read/written by a laser reading/writing device of a PC, must have a central hole and therefore they do not have a surface wholly available for printing visually perceivable information.

### SUMMARY OF THE INVENTION

It is the main object of the present invention to provide a digital carrier equipped with optical storage means that can be read/written by means of a laser reading/writing device, which carrier does not have the drawbacks of the prior art carriers and makes a greater surface available for printing visually detectable information, so as to allow using the carrier in the field of the public administration.

It is another object of the invention to provide a carrier which can include, besides the optical surface, one or more storage means in such a way that said means can be read/written in reading/writing devices capable of receiving cards conforming to ISO standard 7810.

It is another object of the invention to provide a laser reading and/or reading/writing device for use in combination with said carrier.

The carrier according to the invention, which preferably has the shape of a parallelepiped card and has an optical annular surface on one face, has no through hole and both faces thereof are uniformly planar. The face opposite to that bearing the optical surface defines a surface wholly utilizable for printing visually perceivable characters, indicia and images. The carrier further includes, at the center of said optical annular surface, a body that can be magnetically attracted.

The reading and/or reading/writing device according to the invention comprises a laser reading/writing head and a rotor for rotating said carrier, and said rotor comprises a substantially planar contact surface magnetically engaging said carrier.

The device is obtained from a standard device and is modified only in respect of the rotor and the pressure member and, preferably, of the drawer for introducing the carrier into the device. Thus, existing well established and inexpensive reading and writing means can be exploited.

It is to be appreciated that the provision of a dedicated device instead of a standard device is justified in that the invention is specifically intended for use in the public administration.

Some exemplary embodiments of the invention will be described in more detail below. For easiness of description, the carrier body on which the optical annular surface is provided will be referred to as “lower body” and the other one as “upper body”.

### BRIEF DESCRIPTION OF THE DRAWINGS

For the detailed description of some embodiments of the invention reference will be made to the accompanying drawings, in which:

FIG. 1a is a top view of a first embodiment of the carrier according to the invention;

FIG. 1b is a bottom view of the carrier shown in FIG. 1a;

FIG. 1c is a cross-sectional view taken along line A-A of FIG. 1a;

FIG. 2 is a bottom view of a variant embodiment;

FIG. 3a is a top view of a second embodiment of the carrier according to the invention;

FIG. 3b is a bottom view of the carrier shown in FIG. 3a;

FIG. 3c is a cross-sectional view taken along line B-B of FIG. 3a;

FIG. 4 is a plan view of the surface completely utilizable for printing in the carrier according to the invention;

FIG. 5 is a cross-sectional view of the rotor of the reading and/or reading/writing device according to the invention;

FIG. 6a is a cross-sectional view of the rotor—pressure member assembly of the reading and/or reading/writing device according to the invention;

FIG. 6b is a cross-sectional view of the rotor—pressure member assembly of the reading and/or reading/writing device according to a variant of the invention;

FIG. 7 is a top view of the drawer of the reading and/or reading/writing device according to the invention;

FIG. 8a is a top view of the reading and/or reading/writing device according to the invention, having the carrier of FIG. 1a inserted therein;

FIG. 8b is a top view of the reading and/or reading/writing device according to the invention, having the carrier of FIG. 3a inserted therein;

FIG. 8c is a top view of the reading and/or reading/writing device according to a variant embodiment of the invention, having the carrier of FIG. 1a inserted therein;

FIG. 9 is a plan view of a disc-shaped carrier according to the invention.

### DETAILED DESCRIPTION OF PREFERRED EMBODIMENTS

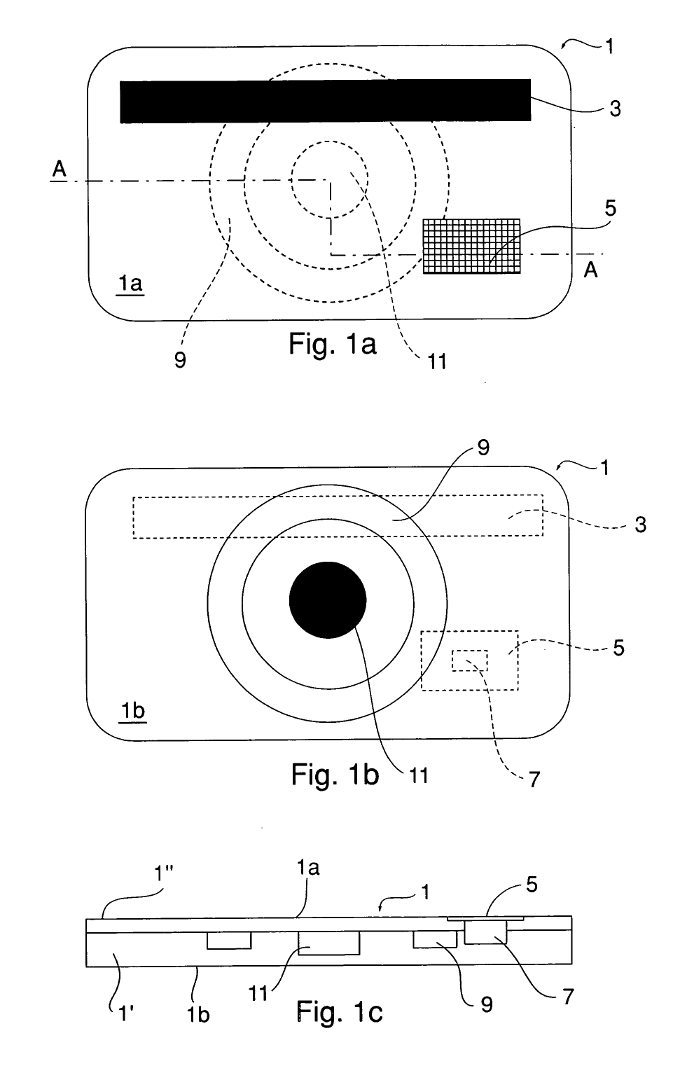

Referring to FIGS. 1a to 1c, there is shown a first embodiment of the carrier according to the invention, in the form of a substantially parallelepiped card 1 with rectangular plan, comprising two superimposed bodies 1′, 1″ of plastic material, e.g. polycarbonate. The card size conforms to ISO standard 7810, is uniform over the whole card and is 86×54×0.76 mm, with an allowed thickness tolerance of ±0.08 mm.

In the alternative, card 1 could be obtained by superimposing, instead of two bodies 1′, 1″, a greater number of bodies, provided the overall thickness of said card 1 is 0.76±0.08 mm. Card 1 might also comprise a single, one-layer body.

Still with reference to FIGS. 1a to 1c, upper body 1″ has a window receiving contact board 5 of a chip 7, so that the board is accessible from the outside. The chip is located in a recess formed in lower body 1′, beneath board 5.

A high coercivity magnetic strip 3, so located that it can always be read in a standard reading apparatus, is applied to free surface 1a of said body 1″. Said face 1a might also have a bar code and/or other graphical indicia printed thereon

Lower body 1′ of hybrid card 1 has in turn an optical annular surface 9 for data storage (generally, with a capacity of about 100 Mbytes), which can be read/written by means of a laser reading/writing device. In this embodiment, said surface 9 is centered with respect to the symmetry center of the card.

Said surface 9 could moreover occupy, either wholly or in part (as in the disclosed example), an annulus surrounding a cylindrical body 11, discussed below, and having a maximum diameter substantially corresponding to the card width.

Advantageously, said annular surface 9 may be easily exploited by using the DVD/CD technology. In such case, surface 9 and lower body 1′ of card 1 receiving said surface have a thickness of about 0.6 mm, conforming to the DVD technology standard. Upper body 1″ may therefore be 0.16±0.08 mm thick, so that the overall thickness of said card 1 conforms to ISO standard 7810.

Advantageously, since chip 7 has a considerably lower size than contact board 5, the recess formed in body 1′ might have a smaller area than the window for board 5, and it will house the chip so that the latter is adjacent to surface 9. Instead, the upper portion housing contact board 5 axially overlaps with surface 9 so as to be compatible with the reading means provided in existing standard apparatuses, such ATMs, POS devices and the like.

Lower body 1′ has, at the center of annular surface 9, a seat capable of receiving said cylindrical body 11, which can be magnetically attracted. Advantageously, the presence of said body 11 allows centering surface 9 with respect to a suitably polarized magnet.

Said body 11 preferably has a diameter of 10 mm and is 0.5 mm thick, and it is located in a corresponding seat of the same diameter and depth formed in carrier 1. Said body 11 will therefore be spaced about 0.10 mm from lower face 1b of body 1′ and about 0.16±0.08 mm from upper face 1a of body 1″.

Body 11 is preferably made of ferrous material, or of a mixture of ferrous and non-ferrous material, such as for instance a rubber mix filled with iron powder. The body thus exhibits good flexibility characteristics, so that the card conforms with ISO standards 7816 and 7810 in respect of the “card maximal bending”, that is the possibility of bending the card, without damaging it, according to two perpendicular axes passing through the card center.

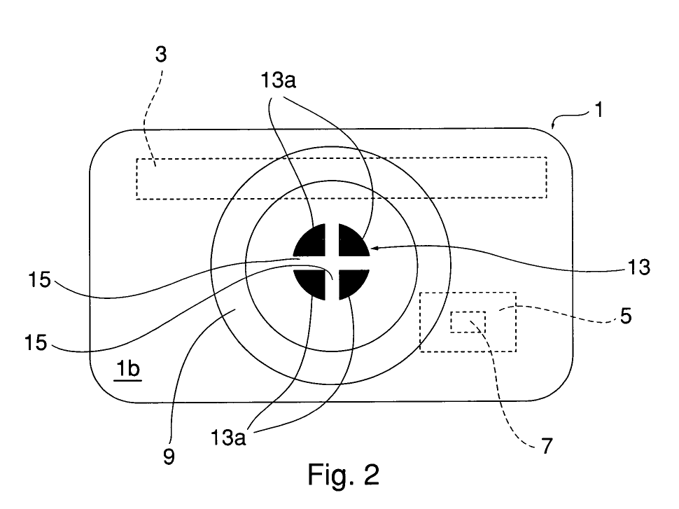

In the alternative, referring to FIG. 2, a cylindrical body 13 divided into sectors or slices 13a and made of ferrous material or of a mixture of ferrous and non-ferrous material could be provided.

In such case, the seat at the center of surface 9 will be divided by two perpendicular partitions 15 so as two define four sectors 13a located inside a circumference having a diameter of about 10 mm. Thanks to that feature, the flexibility characteristics of the card are further improved.

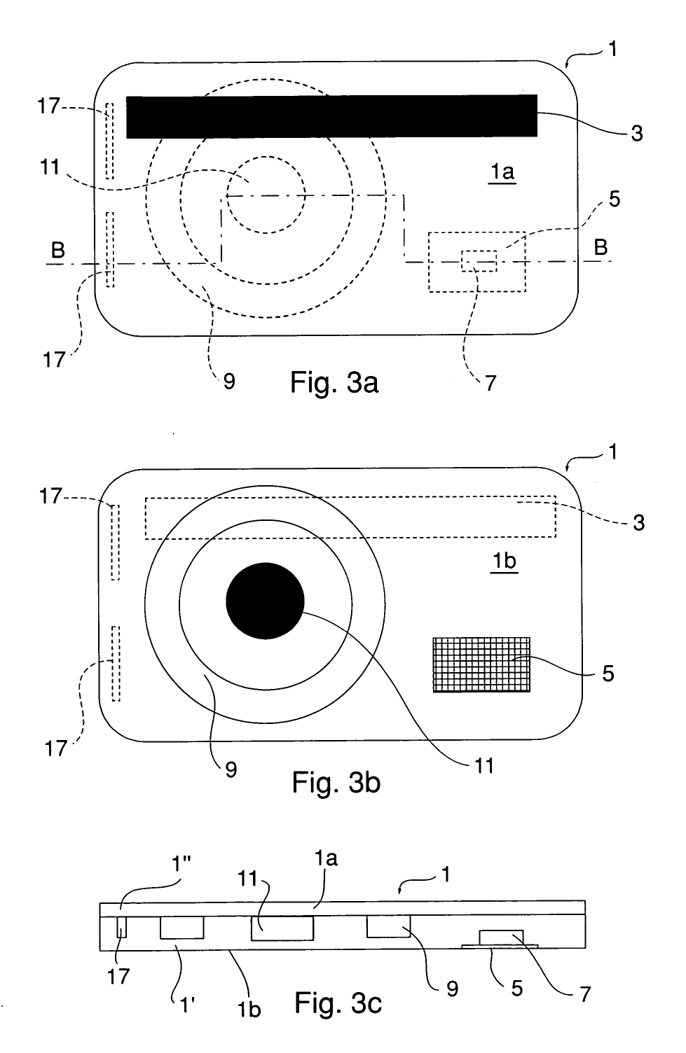

FIGS. 3a to 3c disclose a second embodiment of the carrier according to the invention, still in form of a card 1, where surface 9 is eccentrically located with respect to the symmetry center of card 1.

According to this embodiment, surface 9 and chip 7 could advantageously be provided on the same lower body 1′. Actually, thanks to the eccentric positioning of optical surface 9, contact board 5 of chip 7 can be located on free surface 1b of body 1′ without problems of overlap with said optical surface 9, so that the card can be read by existing standard apparatuses, such ATMs, POS devices and the like.

Similarly to the card shown in FIG. 1a, face 1a might bear a magnetic strip 3 and possibly a bar code.

In that second embodiment, to make card 1 balanced, especially in view of its use inside an optical reading and writing device in which the card is made to rotate, one or more counterweights 17 are provided in corresponding seats formed in lower body 1′.

Advantageously, an antenna and a battery could act as the counterweights, in case of a chip equipped therewith.

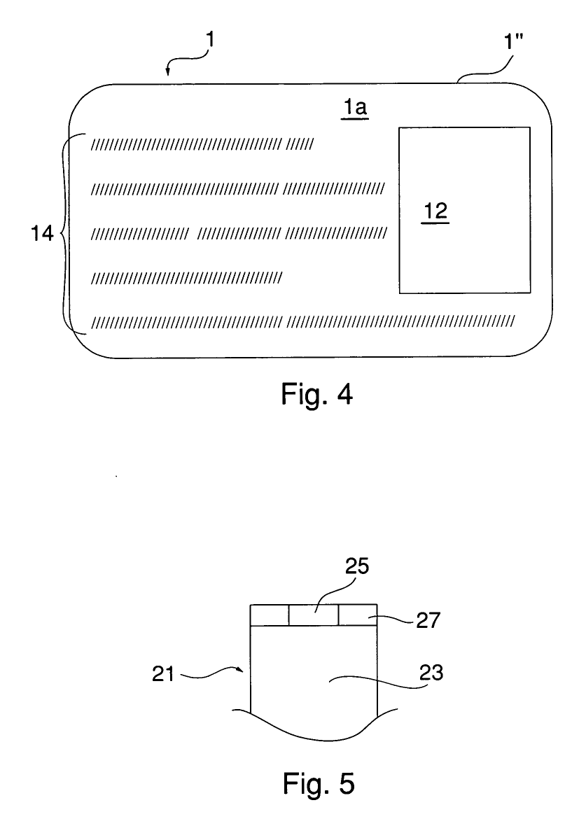

FIG. 4 shows face 1a of body 1″ of a card 1 manufactured as described and shown, said face being wholly available for printing visually perceivable indicia, characters and images. In the illustrated example, the surface of face 1a has been exploited for applying a photo 12 and a set of printed character strings 14. Thus, it is clear that the carrier according to the invention, thanks to the provision of body 11, has no holes and has a surface wholly available for printing processes. Consequently, a card made in accordance with the invention will be better suited than prior art cards for use in the field of the public administration, as identification carrier for various purposes.

FIG. 5 shows rotor 21 of the reading and/or reading/writing device according to the invention.

As known, conventional rotors of the laser reading/writing devices (drives) for personal computers are equipped, at the end that is to enter the CD or DVD through hole, with a circular magnet, placed on a conical base of plastic material and attracting, without contacting it, a corresponding ferrous ring provided on a pressure member placed on the drive cover.

Said rotors further have, at the center of the circular magnet, a cavity capable of engaging a corresponding projection on the pressure member. This ensures that the carrier containing the optical surface, for instance a CD-ROM, is firmly held inside the drive.

According to the invention, rotor 21 has a planar circular contact surface on cylindrical rotor body 23. Said contact surface is obtained by means of a central magnetic disc 25 and of an anti-slip rubber ring 27 surrounding said disc 25.

Magnetic disc 25 consists in a permanent magnet or, in the alternative, in an electromagnet, polarized in parallel direction to the axis of rotor 21.

Thus, when the carrier according to the invention is introduced into the device, said magnetic disc 25 engages cylindrical body 11 (or cylindrical sectors 13) provided centrally of annular surface 9 in the carrier. This allows said carrier to be held and to rotate inside the device while keeping optical annular surface 9 perfectly centered with respect to rotor 21.

Advantageously, magnetic disc 25 has the same diameter as said cylindrical body 11 or 13.

Anti-slip rubber ring 27 assists in obtaining a better hold on the carrier to be read or written. Contrary to the conventional rotors, since no central hole is provided in the optical carrier, in the device according to the invention said ring 27 lies in the same plane as magnetic disc 25, since the magnet is not received in the carrier hole.

Thanks to the magnetic coupling between magnetic disc 25 on rotor 21 and metal body 11 or 13 on the carrier including optical annular surface 9, the reading/writing device can lack the pressure member.

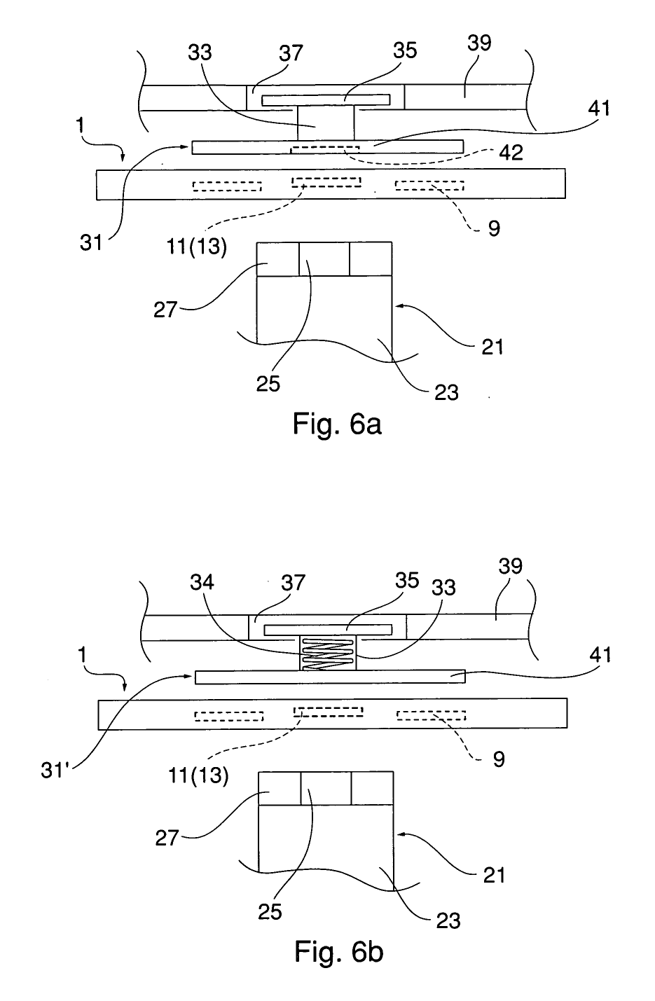

In the alternative, a pressure member can be provided as shown in FIG. 6a.

Pressure member 31 comprises a cylindrical body 33 having at one end a circular base 35 with greater diameter than body 33, which base is capable of keeping the pressure member in a seat 37 formed in the cover or bridge 39 of the reading and/or reading/writing device. At the opposite end, the pressure member has a second planar circular base 41 comprising a disc 42 made of or containing ferrous material.

As shown in FIG. 6a, body 11, or in the alternative body 13, provided centrally of optical surface 9 in card 1, is attracted by magnetic disc 25, the magnetic force of which is exerted, through the ferrous material of body 11 (or 13), also on said disc 42 provided in base 41 of pressure member 31.

Furthermore, said second planar circular base 41 has a diameter greater than body 11 or 13 and preferably equal to the outer diameter of the annular optical surface 9 for contributing in avoiding displacements of card 1 during its rotation in the reading/writing device.

FIG. 6b shows a possible variant embodiment of pressure member 31′. According to said variant, a coil spring 34 is provided inside body 33 in alternative or in addition to disc 42, said spring being arranged to exert a pressure sufficient to keep said second circular base 41 pressed against body 11 (or 13) of card 1 and to prevent any displacement of card 1 during rotation.

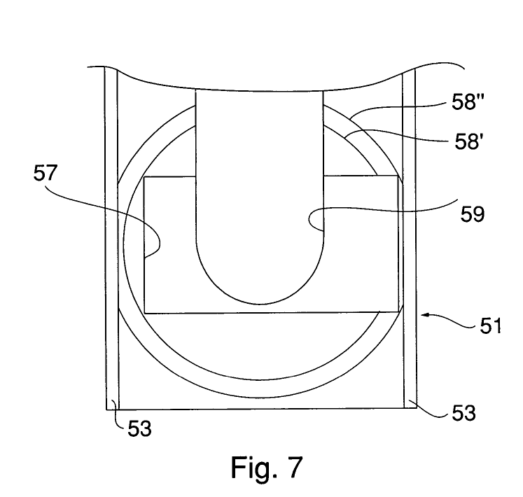

FIG. 7 shows the drawer of the device according to the invention, suitable for receiving rectangular cards.

Drawer 51 has a substantially rectangular plan and is equipped with two side guides 53 in order to be slidable into and out of the housing, not shown, of the reading and/or reading/writing device, in order the carrier can be read/written inside the device and can be placed into and removed from drawer 51, respectively.

According to the invention, drawer 51 has a depressed seat 57, of rectangular shape, for receiving a carrier in the form of a rectangular card.

Advantageously, the seat width will be about the same as that of the card, and its length will be sufficient to allow the proper positioning of optical surface 9 with respect to the reading/writing laser head, both when surface 9 is centrally located in the card plan and when said surface 9 is eccentrically located.

This way, by making the card slide along seat 57, the user can center ferrous body 11 or 13, located centrally of surface 9, with respect to magnetic disc 25 of rotor 21. Thus, once drawer 51 has been wholly introduced inside the reading and/or reading/writing device, surface 9 can be properly read and/or written during card rotation.

In this respect, it is to be appreciated that the outermost edge of card 1 moves at most (i.e. when optical annular surface 9 is eccentrically positioned) along a circumference with a diameter of 120 mm, corresponding to the maximum diameter of CDs read/written in a PC optical drive.

Said drawer 51 has moreover a window 59 making optical annular surface 9 accessible to the laser reader/writer in the reading and writing device during card rotation.

Preferably, drawer 51 might further have a further pair of depressed seats 58′, 58″, of circular shape, centered on the axis of rotor 21 and having the same area as the area swept by the rectangular card during its rotation when surface 9 is centrally located in the card and when said surface 9 is eccentrically located, respectively. Said two further depressed seats 58′, 58″ will have therefore a diameter of about 100 mm or 120 mm, respectively. Thus, when card 1 is released by rotor 21 (as disclosed in more detail hereinafter) when the carrier reading/writing phase is over, the card will be received by the corresponding depressed circular seat 58′, 58″, whatever the card orientation in the plane of drawer 51, in particular when the card orientation does not coincide with that of rectangular seat 57.

As it will become apparent hereinafter, a reader/writer equipped with a standard drawer for CDs or mini-CDs, with circular depressed seats with diameters of 120 mm and 80 mm, could be provided as well.

In such case, should the carrier with the optical surface have a shape and a size different from those of a standard CD or mini-CD, a suitable adapter will be necessary for centering said carrier inside said drawer.

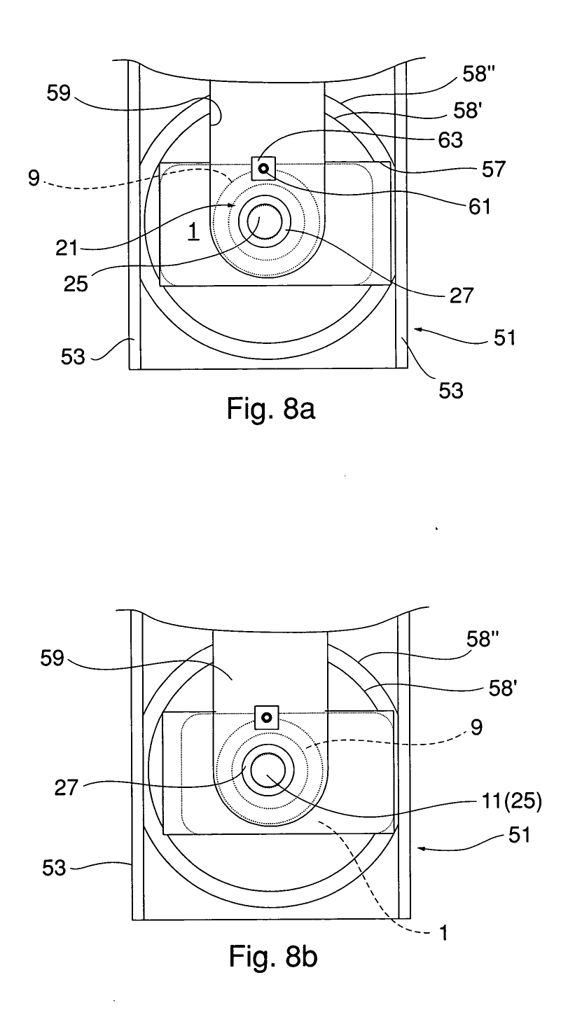

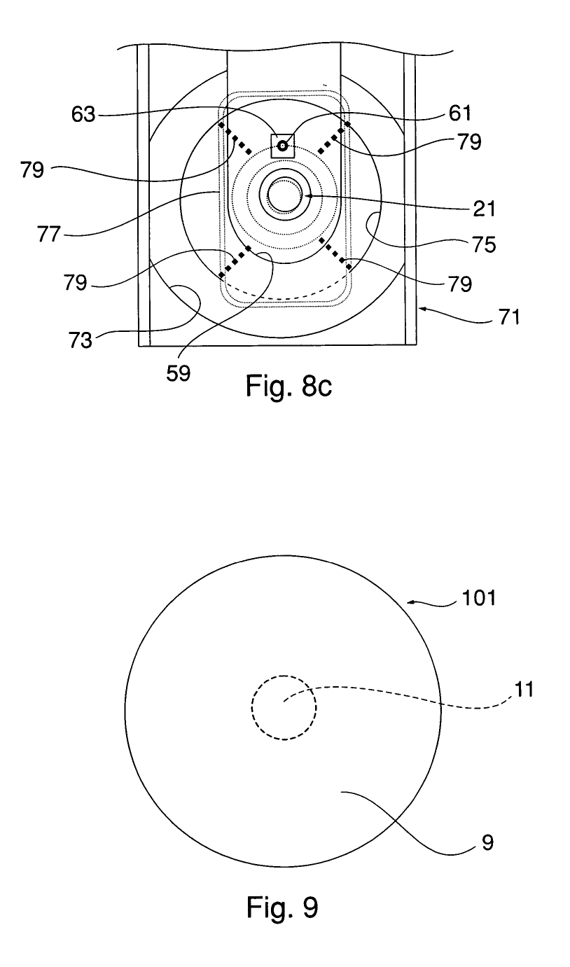

FIG. 8a shows card 1 of FIG. 1a, having a centrally located optical annular surface 9, inside the device for reading and/or reading/writing optical surfaces according to the invention, if said device has a drawer 51 according to the invention.

Drawer 51 is wholly received inside the reading and/or reading/writing device, with card 1 located in seat 57. Cylindrical metal body 11 is aligned with magnetic disc 25 of rotor 21.

Once drawer 51 is wholly introduced into the device by sliding on guides 53, rotor 21 is moved upwards to magnetically engage card 1, thanks to the coupling between cylindrical body 11 and magnetic disc 25. Card 1 is therefore raised with respect to drawer 51 and can freely rotate.

Thanks to the provision of window 59 in drawer 51, head 61 of laser reader/writer 63 has access to the whole optical annular surface 9 during card rotation.

FIG. 8b shows a card 1 as shown in FIG. 2a, with an eccentric optical annular surface 9, inside the device for reading and/or reading/writing optical surfaces according to the invention, if said device has a drawer 51 according to the invention.

As it can be seen, surface 9 in card 1 is in any case centered with respect to the center of rotor 21 and thus it can be correctly read/written, thanks to depressed seat 57 into which said card 1 can be manually slid during introduction.

In FIG. 8c, the reading and/or reading/writing device according to the invention has a modified rotor 21 and a standard drawer 71, with two depressed circular seats 73, 75 with diameter of 120 mm and 80 mm, respectively.

In this case, card 1, in order it can be read/written by the device according to the invention, must be placed into an adapter 77, for instance in the form of a rectangular jacket having an opening on one face to expose optical annular surface 9 to laser head 61. Said adapter 77 might have projections 79 for being centered in correspondence of seat 75 with the smallest diameter of 80 mm in drawer 71.

Similarly, an adapter could be used with such a size that the corners of the adapter itself allow card centering by exploiting depressed seat 73 with diameter of 120 mm.

Turning back to FIG. 6a, the operation of the reading and/or reading/writing device according to the invention will now be described. Rotor 21, when being raised inside the optical reading/writing device, meets disc 11 (or 13) and attracts it, thereby moving carrier 1 upwards. Thereafter, carrier 1 meets base 41 of pressure member 31 and the magnetic force exerted by disc 25 of rotor 21 ensures blocking carrier 1 between pressure member base 41 and rotor 21. Similarly, when the rotor stops and is lowered inside the reading/writing device, carrier 1 first disengages from pressure member 31 and then, when reaching the surface of drawer 51 of the reading and/or reading/writing device, the rotor disengages from disc 11 (or 13) on carrier 1, allowing the card to “land” on the surface of drawer 51, so that card removal is possible.

Even though the invention has been disclosed with reference to a carrier 1 with a body arranged to be magnetically attracted and to a reading/writing device having a magnetic rotor, it is also possible to provide a carrier equipped with a magnet and a rotor with a contact surface arranged to be magnetically attracted.

Moreover, even if in the illustrated embodiments particular reference has been made to a card-shaped carrier, carriers of any shape might be provided as well, more particularly disc-shaped circular carriers lacking the hole and having a ferrous or magnetic body in order to engage the rotor of the reading and/or reading/writing device. In such case, the optically readable/writable annular surface will occupy the whole free surface available around said ferrous or magnetic body.

In this respect, reference is made to FIG. 9, showing a disc-shaped carrier 101 equipped with an optical annular surface 9 and, at the center thereof, a body 11 made of a material that can be magnetically attracted.

1. A digital carrier for data storage, including on a first face an optical annular surface that can be read/written in a laser reading/writing device, wherein said carrier includes, centrally of said annular surface, a body that can be magnetically attracted and wherein the face opposite to said first face in said carrier is wholly utilizable for printing visually perceivable characters, indicia and images.

2. The carrier as claimed in claim 1, wherein said carrier has no through holes.

3. The carrier as claimed in claim 1, wherein said body that can be magnetically attracted comprises a disc.

4. The carrier as claimed in claim 1, wherein said body that can be magnetically attracted comprises a plurality of circular sectors or slices.

5. The carrier as claimed in claim 1, wherein said body that can be magnetically attracted is made of ferrous material.

6. The carrier as claimed in claim 1, wherein said body that can be magnetically attracted is made of a mixture of ferrous and non-ferrous material.

7. The carrier as claimed in claim 6, wherein said body that can be magnetically attracted is made of rubber filled with ferrous material.

8. The carrier as claimed in claim 1, wherein said body that can be magnetically attracted is located in a cavity provided in said carrier.

9. The carrier as claimed in claim 1, made of two or more superimposed bodies glued together.

10. The carrier as claimed in claim 1, made of a single one-layer body.

11. The carrier as claimed in claim 1, wherein a center of said annular surface coincides with a symmetry center of said carrier.

12. The carrier as claimed in claim 1, wherein a center of said annular surface is eccentrically located with respect to a symmetry center of said carrier.

13. The carrier as claimed in claim 1, further including a magnetic strip and/or a chip and/or a bar code.

14. The carrier as claimed in claim 13, wherein said chip is received in a cavity of said carrier and is connected to a contact board accessible from outside said carrier.

15. The carrier as claimed in claim 14, wherein said annular surface is read/written from one side of said carrier, and said contact board is located on said one side.

16. The carrier as claimed in claim 14, wherein said annular surface is read/written from one side of said carrier, and said contact board is located on a carrier side opposite to said one side.

17. The carrier as claimed in claim 1, having a substantially parallelepiped shape.

18. The carrier as claimed in claim 17, conforming to ISO standards 7810/7816.

19. The carrier as claimed in claim 1, having a substantially cylindrical shape.

20. A laser reading and/or reading/writing device for reading/writing digital carriers having an optical annular surface storing data in a form readable/writable by said laser reading and/or reading/writing device, the device comprising a laser reading/writing head and a rotor for rotating said carrier, wherein said rotor comprises a substantially planar contact surface magnetically engaging said carrier.

21. The device as claimed in claim 20, wherein said contact surface comprises a central cylindrical body capable of magnetically attracting or of being magnetically attracted, said body being surrounded by an anti-slip ring of soft material, preferably rubber, said body and said ring having substantially coplanar contact surfaces.

22. The device as claimed in claim 21, wherein said cylindrical body is a permanent magnet with a N-S axis parallel to a rotation axis of said rotor.

23. The device as claimed in claim 21, wherein said cylindrical body is an electromagnet with a N-S axis parallel to a rotation axis of said rotor.

24. The device as claimed in claim 20, comprising a drawer for receiving said carrier to be read/written in said device, said drawer and/or said carrier having means for centering said annular surface with respect to a center of said rotor.

25. The device as claimed in claim 24, wherein said drawer comprises a depressed seat having the same shape as said carrier and arranged to receive a correspondingly shaped carrier.

26. The device as claimed in claim 24, wherein said drawer comprises a depressed seat having a substantially rectangular shape and arranged to receive a correspondingly shaped carrier, and wherein said seat is so sized as to house a rectangular carrier having an optical annular surface centrally or eccentrically located with respect to a symmetry center of said rectangular carrier.

27. The device as claimed in claim 26, wherein said drawer further comprises a first and a second additional depressed seat, of substantially circular shape, centered in correspondence of a rotation axis of said rotor, said seats having each a respective area corresponding to an area swept by said rectangular carrier during its rotation about said rotation axis when said rectangular carrier has an optical annular surface centrally or eccentrically located with respect to the symmetry center of said carrier, respectively.

28. The device as claimed in claim 20, comprising a cover or a bridge located above said laser reading/writing head and said rotor, said cover or said bridge including a pressure member axially aligned with a rotation axis of said rotor, said pressure member having a substantially planar contact surface including a member capable of being magnetically attracted, and co-operating with the contact surface of said rotor to keep said digital carrier in engagement with said rotor.

29. The device as claimed in claim 20, comprising a cover or a bridge located above said laser reading/writing head and said rotor, said cover or said bridge including a pressure member axially aligned with a rotation axis of said rotor, said pressure member having a substantially planar contact surface and a resilient member, such as a coil spring, to keep said contact surface pressured against said digital carrier, so that said contact surface co-operates with the contact surface of said rotor to keep said digital carrier in engagement with said rotor.

30. The device as claimed in claim 28, wherein said substantially planar contact surface has a diameter greater than said body that can be magnetically attracted and preferably equal to the outer diameter of said optical annular surface.

31. The device as claimed in claim 29, wherein said substantially planar contact surface has a diameter greater than said body that can be magnetically attracted and preferably equal to the outer diameter of said optical annular surface.
